(19) United States
(12) Patent Application Publication
(10) Pub. No.: US 2013/0325600 A1
(43) Pub. Date: Dec. 5, 2013

(54) Image-Content Matching Based on Image Context and Referrer Data

(71) Applicants: James R. Everingham, Santa Cruz, CA (US); Michael A. McCreavy, Mountain View, CA (US)

(72) Inventors: James R. Everingham, Santa Cruz, CA (US); Michael A. McCreavy, Mountain View, CA (US)

(73) Assignee: Luminate, Inc.

(21) Appl. No.: 13/486,628

(22) Filed: Jun. 1, 2012

(51) Int. Cl. G06Q 30/02

(52) U.S. Cl. 705/14.49

(57) ABSTRACT

Disclosed herein are computer-implement systems and methods for identifying and matching contextually relevant content (e.g., advertisements, text, images, videos, etc.) to images published on digital content platforms (e.g., webpages, mobile applications, etc.). In general, embodiments of the present invention include: (a) receiving an image published on a digital content platform; (b) receiving referrer data from the digital content platform; (c) submitting the image and the referrer data to an image-content matching engine to (1) identify the context of the image and (2) identify contextually relevant content based on the context of the image and the referrer data; and (d) providing the contextually relevant content to the digital content platform for publication proximate to the image.

### SUMMARY

Disclosed herein are computer-implement systems and methods for identifying and matching contextually relevant content (e.g., advertisements, text, images, videos, etc.) to images published on digital content platforms (e.g., webpages, mobile applications, etc.). In general, embodiments of the present invention include: (a) receiving an image published on a digital content platform; (b) receiving referrer data from the digital content platform; (c) submitting the image and the referrer data to an image-content matching engine to (1) identify the context of the image and (2) identify contextually relevant content based on the context of the image and the referrer data; and (d) providing the contextually relevant content to the digital content platform for publication proximate to the image.

### BRIEF DESCRIPTION OF THE FIGURES

The accompanying drawings, which are incorporated herein, form part of the specification. Together with this written description, the drawings further serve to explain the principles of, and to enable a person skilled in the relevant art(s), to make and use the claimed systems and methods.

FIG. 1 is a high-level diagram illustrating an embodiment of the present invention.

FIG. 2 is a high-level diagram illustrating another embodiment of the present invention.

FIG. 3 is a high-level diagram illustrating yet another embodiment of the present invention.

FIG. 4 is a flowchart illustrating a method, in accordance with one embodiment presented herein.

### DEFINITIONS

Prior to describing the present invention in detail, it is useful to provide definitions for key terms and concepts used herein. Unless defined otherwise, all technical and scientific terms used herein have the same meaning as commonly understood by one of ordinary skill in the art to which this invention belongs.

“Advertisement” or “ad”: One or more images, with or without associated text, to promote or display a product or service. Terms “advertisement” and “ad,” in the singular or plural, are used interchangeably.

“Ad Creative” or “Creative”: Computer file with advertisement, image, or any other content or material related to a product or service. As used herein, the phrase “providing an advertisement” may include “providing an ad creative,” where logically appropriate. Further, as used herein, the phrase “providing a contextually relevant advertisement” may include “providing an ad creative,” where logically appropriate.

Ad server: One or more computers, or equivalent systems, which maintains a catalog of creatives, delivers creative(s), and/or tracks advertisement(s), campaigns, and/or campaign metrics independent of the platform where the advertisement is being displayed.

Campaign: The process or program of planning, creating, buying, and/or tracking an advertising project.

“Contextual information” or “contextual tag”: Data related to the contents and/or context of digital content (e.g., an image, or content within the image); for example, but not limited to, a description, identification, index, or name of an image, or object, or scene, or person, or abstraction within the digital content (e.g., image).

Contextually relevant advertisement: A targeted advertisement that is considered relevant to the contents and/or context of digital content on a digital content platform.

Crowdsource network: One or more individuals, whether human or computer, used for a crowdsourcing application.

Crowdsourcing: The process of delegating a task to one or more individuals, with or without compensation.

Digital content: Broadly interpreted to include, without exclusion, any content available on a digital content platform, such as images, videos, text, audio, and any combinations and equivalents thereof.

Digital content platform: Broadly interpreted to include, without exclusion, any webpage, website, browser-based web application, software application, mobile device application (e.g., phone or tablet application), TV widget, and equivalents thereof.

Image: A visual representation of an object, or scene, or person, or abstraction, in the form of a machine-readable and/or machine-storable work product (e.g., one or more computer files storing a digital image, a browser-readable or displayable image file, etc.). As used herein, the term “image” is merely one example of “digital content.” Further, as used herein, the term “image” may refer to the actual visual representation, the machine-readable and/or machine-storable work product, location identifier(s) of the machine-readable and/or machine-storable work product (e.g., a uniform resource locator (URL)), or any equivalent means to direct a computer-implemented system and/or user to the visual representation. As such, process steps performed on “an image” may call for different interpretations where logically appropriate. For example, the process step of “analyzing the context of an image,” would logically include “analyzing the context of a visual representation.” However, the process step of “storing an image on a server,” would logically include “storing a machine-readable and/or machine-storable work product, or location identifier(s) of the machine-readable and/or machine-storable work product (e.g., uniform resource locator (URL)) on a server.” Further, process steps performed on an image may include process steps performed on a copy, thumbnail, or data file of the image.

Merchant: Seller or provider of a product or service; agent representing a seller or provider; or any third-party charged with preparing and/or providing digital content associated with a product or service. For example, the term merchant should be construed broadly enough to include advertisers, an ad agency, or other intermediaries, charged with developing a digital content to advertise a product or service.

Proximate: Is intended to broadly mean “relatively adjacent, close, or near,” as would be understood by one of skill in the art. The term “proximate” should not be narrowly construed to require an absolute position or abutment. For example, “content displayed proximate to an image,” means “content displayed relatively near an image, but not necessarily abutting or within the image.” (To clarify: “content displayed proximate to an image,” also includes “content displayed abutting or within the image.”) In another example, “content displayed proximate to an image,” means “content displayed on the same screen page or webpage as the image.”

Publisher: Party that owns, provides, and/or controls digital content or a digital content platform; or third-party who provides, maintains, and/or controlls, digital content and/or ad space on a digital content platform.

### INCORPORATION BY REFERENCE OF RELATED APPLICATIONS

Except for any term definitions that conflict with the term definitions provided herein, the following related, co-owned, and co-pending applications are incorporated by reference in their entirety: U.S. patent application Ser. Nos. 12/902,066; 13/005,217; 13/005,226; 13/045,426; 13/151,110; 13/219,460; 13/252,053; 13/299,280; 13/308,401; 13/299,280; 13/427,341; and 13/450,807.

### DETAILED DESCRIPTION

Disclosed herein are computer-implement systems and methods for identifying and matching contextually relevant content (e.g., advertisements, text, images, videos, etc.) to images published on digital content platforms (e.g., webpages, mobile applications, etc.). The systems and methods presented are particularly useful for third-parties (e.g., merchants, advertisers, and/or content developers) to associate their content (e.g., products, advertisements, in-image applications, etc.) with published images. In general, embodiments of the present invention include receiving an image and referrer data from a digital content platform. The image and the referrer data is then submitted to an image-content matching engine. The image-content matching engine generally identifies the context of the image, and identifies contextually relevant content to match, or otherwise associate, with the image. The contextually relevant content is selected based on the context of the image and the referrer data. The contextually relevant content is then provided to the digital content platform for publication proximate to the image. As such, an end-user of the digital content platform, who is interested in the originally published image, can also be served with additional contextually relevant content. Additional embodiments and sub-protocols are described in more detail below.

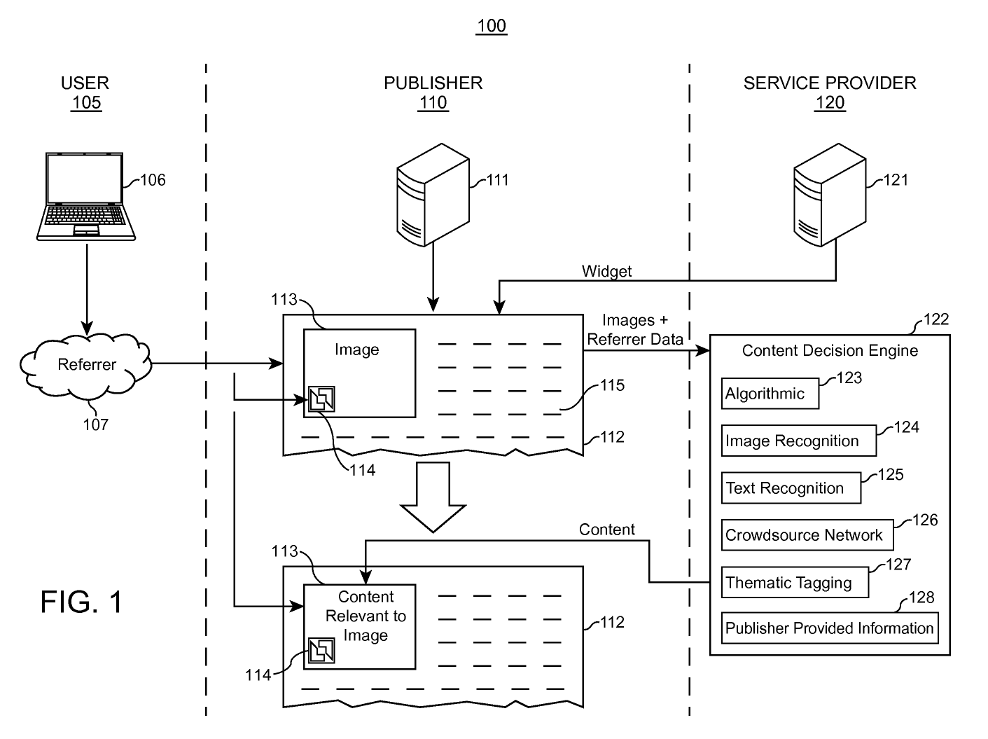

For example, FIG. 1 is a high-level diagram illustrating an embodiment of the present invention. More specifically, FIG. 1 shows a system and method 100 of identifying, providing, and displaying digital content on a digital content platform. As shown in FIG. 1, a user 105 employs an end-user device 106 (e.g., a computer, tablet, mobile phone, television, etc.) to access a publisher's 110 digital content platform 112, via a Referrer 107 (e.g., a search engine on the Internet). The digital content platform 112 may be a web page, website, browser-based web application, software application, mobile device application (e.g., phone or tablet application), TV widget, or equivalents thereof. In practice, the publisher 110 publishes digital content (e.g., one or more images 113 and/or text 115) on the digital content platform 112.

A service provider 120 provides a software widget (e.g., web widget, executable computer code, computer-readable instructions, reference script, HTML script, etc.) for inclusion in the digital content platform 112. In one embodiment, the software widget analyzes the digital content platform in order to identify any and all of the images published on the platform. For example, the software widget can provide the function of “scraping” the platform for images (e.g., by walking the DOM nodes on an HTML script of a web page). In one embodiment, the software widget can be configured to identify published images that meet predefined characteristics, attributes, and/or parameters. Additionally, the software widget can provide the function of scraping the platform to identify any and all “referrer data.” The software widget then provides (or otherwise identifies) the images and the referrer data to the service provider 120 for further analysis.

As used herein, the term “referrer data” should be broadly interpreted to include any information, data, or like means for identifying the entity, location, function, platform, or equivalent network conduit that brought the user 105 to the digital content platform 112. For example, in the embodiment wherein the digital content platform 112 is a web page, the referrer (or referring page) may be the uniform resource locator (URL) of the previous web page, from which a link was followed. The referrer data may also include a search engine and/or search query entered by the user 105 to find and access the digital content platform 112. In one embodiment, the referrer data includes an HTTP referer, which is the commonly known misspelling of the referrer that occurs as an HTTP header field. The HTTP referer identifies, from the point of view of an Internet web page or resource, the address of the web page that links to the digital content platform 112. For example, when the user 105 clicks a link in a web browser, the browser sends a request to the server holding the destination web page. The request includes the referer field (i.e., referrer data), which identifies the last page the user 105 was on (i.e., the page where the user clicked the link to the current page). Referer logging is used to allow websites and web servers to identify where people are visiting them from, for promotional or security purposes. In the embodiments presented herein, the referrer data is used to supplement and enhance the analysis of images published on a digital content platform.

The analysis of the images typically occurs within a content decision engine 122, which may run within or in conjunction with the service provider's dedicated content server 121. Within the content decision engine 122, the one or more published images 113 are analyzed to identify contextually relevant content associated with the published image. For example, if the image 113 depicts a professional athlete, contextually relevant content may include information about the athlete's career, recent activities, associated product advertisements, etc. In another example, if the image 113 depicts a vacation setting, the contextually relevant content may include where the setting is located, advertisements on how to get to the vacation site, and other relevant information. Contextually relevant content may also include one or more third-party, in-image applications, which function based in part on the content/context/analysis of the image. Such contextually relevant content is then provided back to the digital content platform 112, for publication proximate to the image 113, as further discussed below.

To function as a means for identifying contextually relevant content for the image 113, the content decision engine 122 may employ analysis system components such as: algorithmic identification 123 for analysis of the image; image recognition protocols 124; proximate text recognition 125 in search of contextual information of the image based on text 115 published proximate to the image 113; submission of the image to a crowdsource network 126 to identify the context of the image and tag the image with relevant data; a thematic tagging engine 127 to identify and tag the image with relevant data, based on a pre-defined theme; publisher provided information database 128; and/or any combinations or equivalents thereof. Aspects of the system components of the content decision engine 122 are described in the above identified related applications, which have been incorporated by reference herein.

For example, within the algorithmic identification system component 123, an analysis may be performed to identify data, tags, or other attributes of the image. Such attributes may then be used to identify and select contextually relevant content that matches the same attributes. For example, an algorithm may be provided that identifies contextually relevant content having the same subject tag and size of the published image. Such contextually relevant content is then provided back to the end-user device for display in spatial relationship with the originally published image.

Image recognition system component 124 may employ one or more image recognition protocols in order to identify the subject matter of the image. An output of the image recognition system component 124 may then be used to identify and select contextually relevant content to be provided back to the end-user device. Image recognition algorithms and analysis programs are publicly available; see, for example, Wang et al., “Content-based image indexing and searching using Daubechies' wavelts,” Int J Digit Libr (1997) 1:311-328, which is herein incorporated by reference in its entirety.

Text recognition system component 125 may collect and analyze text that is published proximate to the image. Such text may provide contextual clues as to the subject matter of the image. Such contextual clues may then be used to identify and select contextually relevant content to be provided back to the end-user device. Examples of text recognition system components are described in U.S. patent application Ser. No. 13/005,217, which has been incorporated herein by reference.

A crowdsource network 126, alone or in combination with the additionally mentioned system components, may also be provided to identify and select contextually relevant content. In one embodiment, for example, a crowdsource network is provided with an interface for receiving, viewing, and/or tagging images published on one or more digital content platforms. The crowdsource network can be used to identify the context of the image and/or identify and select contextually relevant content that is associated with the image. The crowdsource network may be provided with specific instructions on how to best match images with associated content.

A thematic tagging engine 127, alone or in combination with the additionally mentioned system components, may also be provided to identify and select contextually relevant content. In one embodiment, for example, the thematic tagging engine works in conjunction with a crowdsource network to receive, view, and/or tag images published on one or more digital content platforms based on specific themes. Themes may include marketable considerations provided by one or more third-party merchants wishing to use the published images as an advertising mechanism. Examples of thematic tagging systems are described in more detail in U.S. patent application Ser. No. 13/299,280, which has been incorporated herein by reference.

The content decision engine 122 may also be directly linked to the publisher 110 to collect publisher provided information 128 with respect to the published image. For example, the publisher 110 may provide criteria for selecting which images are subject to analysis. The publisher 110 may also be provided with a “dashboard” or interface to configure various settings for the service provider's analysis. For example, the publisher can select what categories of contextually relevant content (e.g., in the form of informational categories, interactive functions, etc.) to be provided with respect to the published images. In one example, the publisher 110 may select interactive applications as described in U.S. patent application Ser. No. 12/308,401, which has been incorporated herein by reference. The publisher 110 may also select what third-party merchants may be used to provide advertisements for any particular image (or subset of images).

In operation, the service provider's software widget monitors the user's 105 interactions with the image 113. If the user 105 activates the image (by, for example, clicking on a hotspot 114, mousing-over the image, viewing the image for a defined period of time, etc.), the software widget sends a call to the service provider 120 (e.g., the service provider's content server 121 and/or content decision engine 122) to request contextually relevant content for the image. The software widget (or an associated “child” widgets) receives the contextually relevant content from the service provider 120, and then displays the contextually relevant content proximate to the originally published image. In one embodiment, the software widget displays the contextually relevant content within the same pixel profile (i.e., the same pixel space) of the originally published image 113. As such, the contextually relevant content can be displayed without affecting any of the other content published on the digital content platform 112. Further, by providing the contextually relevant content within a spatial relationship with respect to the image 113, the user 105 is more focused on the contextually relevant content, without ruining the original aesthetic design provided by the publisher 110.

Each of the above-listed system components is further supplemented by the referrer data. As such, the content decision engine 122 (and/or any of the described sub-protocols) may consider both the context of the image and the situational context of where/what has directed the user 105 to the digital content platform 112. For example, in one embodiment the digital content platform 112 may be a sports news web page. The image 113 may be an image of the New England Patriots' quarterback Tom Brady. In practice, the image 113 of Tom Brady can be processed by the content decision engine 122, in which case the content decision engine may return a video clip of Tom Brady as contextually relevant content that is published (or otherwise played) when the user 105 activates the hotspot 114. However, if the referrer data is also provided to the content decision engine 122, such referrer data may be used to better understand the user's intentions, and thus provide contextually relevant content with a higher degree of specificity. For example, if the referrer data indicates that the user 105 has accessed the digital content platform 112 from the website of the Miami Dolphins, the content decision engine 122 may provide an advertisement for the sale of tickets to the New England Patriots versus Miami Dolphins game. On the other hand, if the referrer data indicates that the user 105 has accessed the digital content platform 112 from a search engine, wherein the user 105 enters the search term “Tom Brady jersey,” the content decision engine 122 may use such referrer data to provide an advertisement for the sale of Tom Brady jerseys when the user 105 activates the hotspot 114. As such, the referrer data may be used to provide very user-specific contextually relevant content.

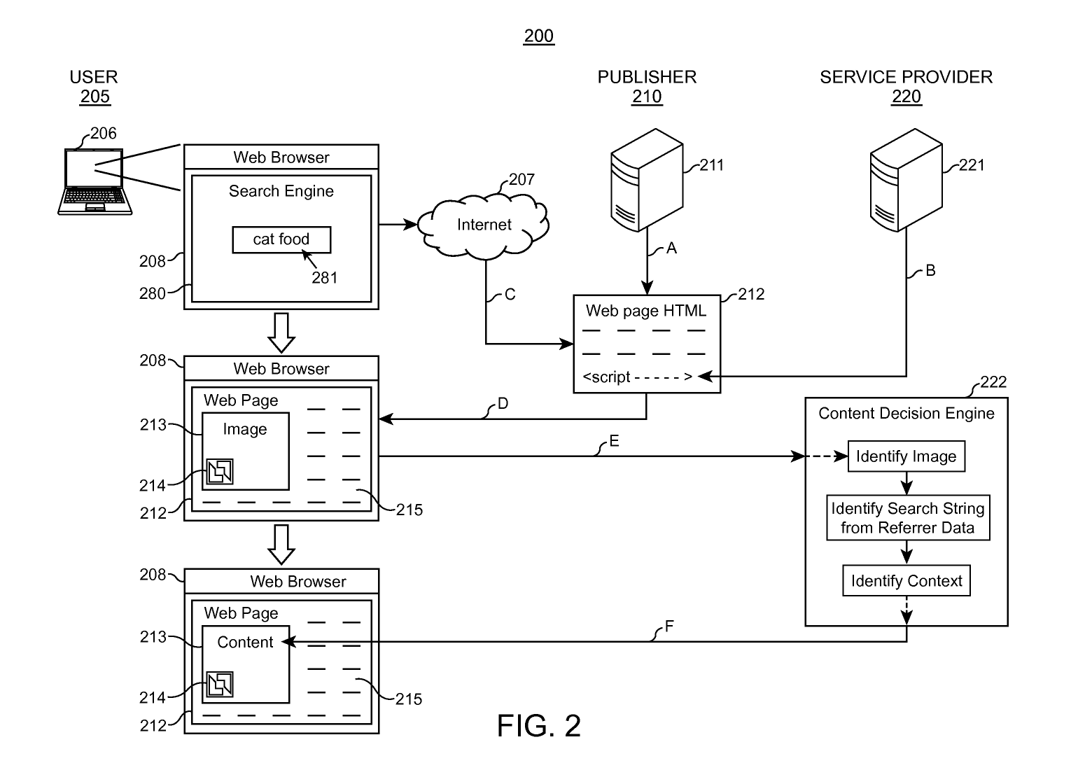

FIG. 2 is a high-level diagram illustrating another embodiment of the present invention. In FIG. 2, arrows A-F show the process flow of the system and method 200. The system and method 200 of FIG. 2 is described with relation to a digital content platform in the form of a web page. As would be understood by one of skill in the art, the system and method 200 may also be employed in various equivalent digital content platforms, such as, browser-based web applications, software applications, mobile device applications (e.g., phone or tablet applications), TV widgets, or equivalents thereof.

In operation, a publisher 210 maintains an HTML web page script 212 on a server 211 (Arrow A). The publisher 210 also inserts a reference script directed to a dedicated content server 221 maintained by a service provider 220 (Arrow B). A user 205 then employs an end-user device 206, a web browser 208, and a referrer (e.g., a search engine) 280 to access the HTML web page script 212 via the Internet 207 (Arrow C). The user's web browser 208 then loads the HTML web page script as a viewable web page 212 within the web browser 208. The web page 212 may include content such as an image 213 and text 215. The image may include one or more hotspots 214, or other means of activating the image. In one embodiment, the image 213 is not originally published with a hotspot 214, but instead has a hotspot activated after the service provider 220 has identified and analyzed the image.

Arrow E indicates the reference script calling to the service provider 220, and more specifically to the content decision engine 222, in order for the service provider to receive identification of the image and the referrer data. The referrer data may include the identification of the search engine 280 and/or a search string/query (e.g., “cat food”) 281 entered into the search engine. The service provider then uses the image and the referrer data to identify content that is contextually relevant to the image. For example, in the embodiment shown, the content decision engine 222 performs the functions of (1) identifying the image, (2) identifying a search string from the referrer data, and (3) identifying the context of the image, search string, and/or any other relevant data. Such identified information is used to identify contextually relevant content for publication proximate to the image 213. Such contextually relevant content is then returned to the end-user device 206 for display within the web browser 208, as shown by Arrow F. In one embodiment, the contextually relevant content is published proximate to the originally published image 213. For example, the contextually relevant content may be shown within the same pixel frame (or pixel profile) as the originally published image 213. In practice, the reference script may be used to initiate a direct data link between the end-user device 206 and the service provider 220. In one embodiment, such direct data link is provided by creating a direct communication link (not shown) between the end-user device 206 and the content server 221. As such, the service provider 220 can deliver executable code (or text instructions that can be compiled into executable code) directly to the end-user device 206. In one embodiment, the executable code (or instructions) is processed by the web browser 208 on the end-user device 206 to display the contextually relevant content in a spatial relationship with respect to the image 213. Such executable code (or instructions) may be configured to modify or otherwise animate the image in order to highlight to the user 205 that the contextually relevant content is specifically related to the image 213.

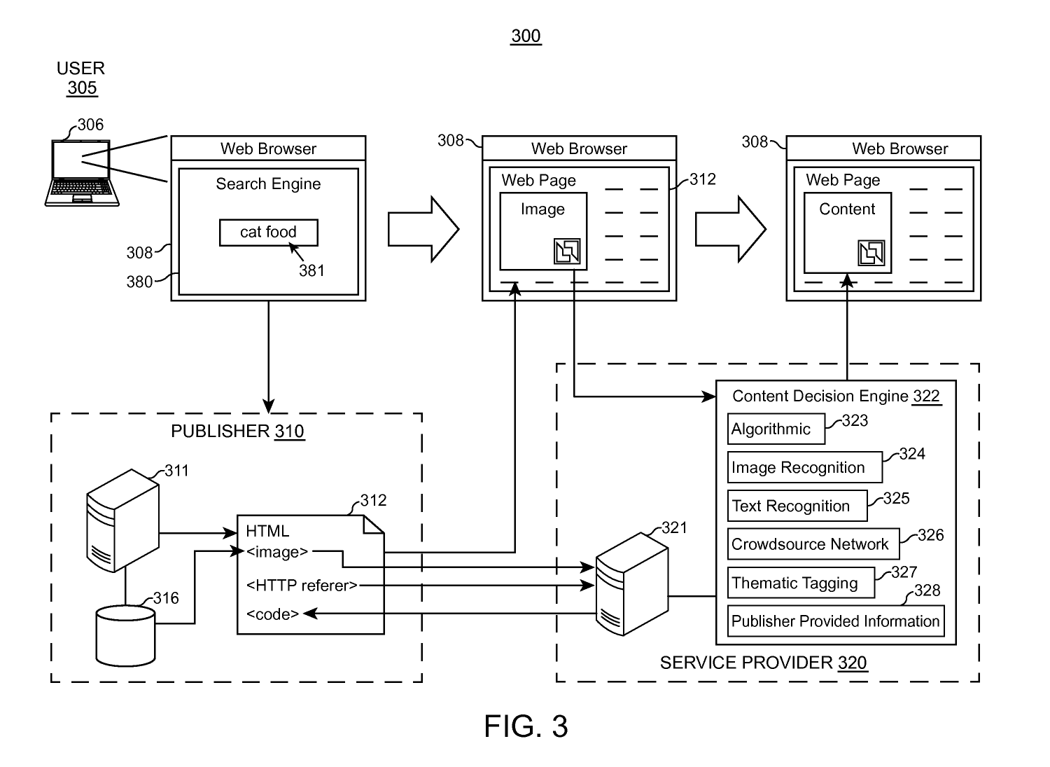

FIG. 3 is a high-level diagram illustrating yet another embodiment of a system and method 300 for displaying contextually relevant content in association with an image published on a digital content platform. As in FIG. 2, the system and method 300 of FIG. 3 is described with relation to a digital content platform in the form of a web page. As would be understood by one of skill in the art, however, the system and method 300 may also be employed in various equivalent digital content platforms, such as, browser-based web applications, software applications, mobile device applications (e.g., phone or tablet applications), TV widgets, or equivalents thereof.

As shown, a publisher 310 provides an HTML web page 312 from its server 311, and includes a reference to an image on its image database 316, and an embed code received from the service provider 320. A user 305 then employs an end-user device 306, a web browser 308, a search engine 380, and a search query 381 to access the web page script 312 on the publisher's server 311. The user's web browser 308 then loads the web page 312. The web page 312 may include content such as an image 313 and text 315, and source page information including the HTTP referer. The image may include one or more hotspots 314, or other means of activating the image. In one embodiment, the image 313 is not originally published with a hotspot 314, but instead has a hotspot activated after the service provider 320 has identified and analyzed the image.

The embed code functions to call on the service provider 320. The embed code may also create a direct link between the end-user device 306 and the service provider 320. As such, the service provider 320 can deliver software code (or corresponding computer-readable instructions) that function to: 1) identify one or more images published on the web page, 2) identify the HTTP referer, 3) identify and/or set event handlers that watch for user activity; and/or 4) collect data on the image, text, user, publisher, and any other valuable information for analyzing the image and identifying contextually relevant content that may be beneficial to the user. In one embodiment, the software code (or corresponding computer-readable instructions) may be pre-configured (by the service provider 320, the publisher 310, and/or a third-party merchant) to only identify and analyze images that meet certain pre-set criteria. For example, if the publisher 310 wants to use his images for advertisement purposes, the service provider 320 can identify images that meet marketable requirements (set by either the publisher or a third-party merchant) in order to identify contextually relevant advertisements to display in a spatial relationship with the image.

After identifying the published image and the HTTP referer, the service provider 320 processes the image (or multiple images) and the HTTP referer through a content decision engine 322, in order to identify content that is contextually relevant to the image(s). Such contextually relevant content is based on the context within the image and the referrer data within the HTTP referer. The contextually relevant content is then returned to the end-user device 306 for display within the web browser 308. The service provider 320 may also provide executable code (or computer-readable instructions that can be compiled into executable code) to modify or otherwise animate the image in order to highlight to the user 305 that the contextually relevant content is specifically related to the image 313. For example, in one embodiment, the executable code (or computer-readable instructions that can be compiled into executable code) employs CSS language to perform a flip animation on the image 313, so as to show the contextually relevant content on the apparent backside of the image. Preferably, the executable code (or computer-readable instructions that can be compiled into executable code) displays the contextually relevant content within the same pixel profile (i.e., the same pixel space, or same screen location) of the originally published image 313. As such, the contextually relevant content can be displayed without affecting any of the other content published on the web page 312.

To function as a means for identifying contextually relevant content for the image 313, the content decision engine 322 may employ analysis system components such as: algorithmic identification 323 for analysis of the image; image recognition protocols 324; proximate text recognition 325 in search of contextual information of the image based on text 315 published proximate to the image 313; submission of the image to a crowdsource network 326 to identify the context of the image and tag the image with relevant data; a thematic tagging engine 327 to identify and tag the image with relevant data, based on a pre-defined theme; publisher provided information database 328; and/or any combinations or equivalents thereof.

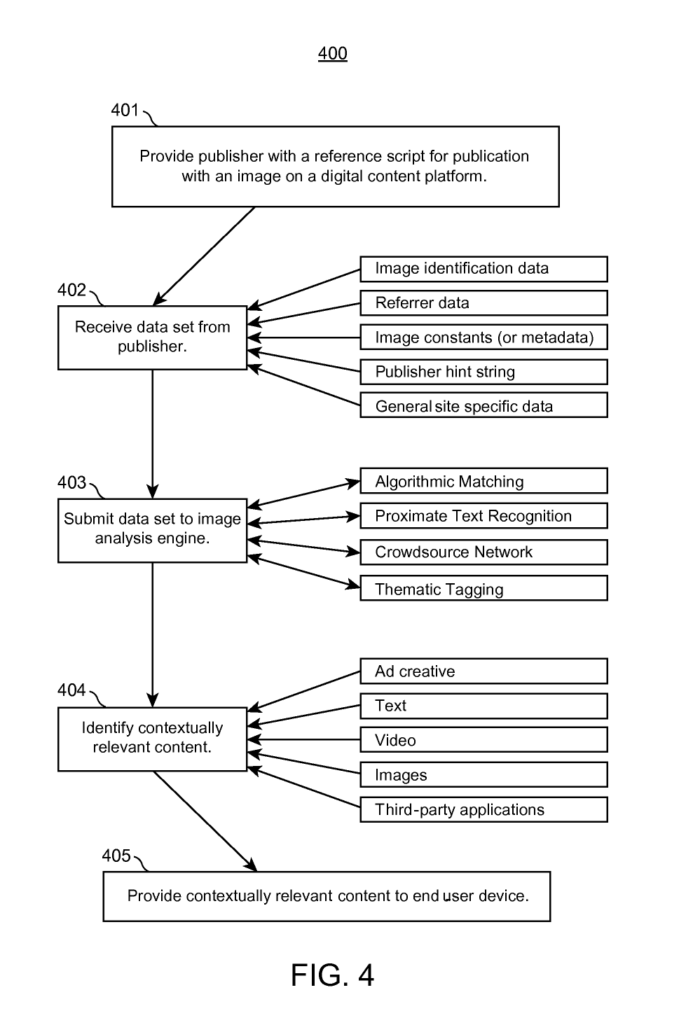

FIG. 4 is a flowchart illustrating a method 400, in accordance with one embodiment presented herein. In step 401, a publisher is provided with a reference script for publication with an image on a digital content platform. In step 402, a data set is received from the publisher. The data set may include inputs such as: image identification data, referrer data, image constants (or metadata, or annotations), publisher hint strings, and/or any other general site specific data. In step 403, the data set is submitted to an image analysis engine. The image analysis engine may include: an algorithmic matching engine, a proximate text recognition engine, a crowdsourcing network, and/or a thematic tagging engine. In step 404, contextually relevant content is identified based on the context of the image and the referrer data. The contextually relevant content may be in many forms; for example, a contextually relevant ad creative, text, videos, images, third-party applications, etc. In step 405, the contextually relevant content is provided to the end user's device for publication proximate to the originally published image.

### Additional Embodiments.

In another embodiment, there is provided computer-implement systems and methods for selecting ad creative based on an image published on a digital content platform, and search query data received from a referrer site. For example, there is provided a method for providing a contextually relevant advertisements proximate to an image published on a digital content platform. The method comprises providing a publisher with a reference script for publication with an image on a digital content platform, wherein the reference script is a computer-readable instruction that causes an end-user device to send data to a service provider processing unit. The data includes (1) image identification data, and (2) referrer data. The method further comprises configuring a service provider processing unit to perform the steps of: (a) receiving the data from a publisher; (b) submitting the data to an image-content matching engine, wherein the image identification data and the referrer data are used to match a contextually relevant advertisement to the image; and (c) providing the contextually relevant advertisement to the end-user device for publication proximate to the image on the digital content platform. The image identification data may include: an image uniform resource locator (URL); an image file; image constants, wherein the image constants are also used by the image-content matching engine to match the contextually relevant advertisement to the image; a publisher hint string, and wherein the publisher hint string is also used by the image-content matching engine to match the contextually relevant advertisement to the image; and/or publisher data, and wherein the publisher data is also used by the image-content matching engine to match the contextually relevant advertisement to the image. The referrer data may include: a search string submitted by the end-user in order to be referred to the digital content platform; identification of a search engine that has referred the end-user to the digital content platform; a search string entered by end-user at the search engine prior to being referred to the digital content platform; a search string; and/or an HTTP referer. The image-content matching engine may include a crowdsourcing network and/or an image recognition engine. The contextually relevant advertisement may be provided in the form of an ad creative and/or may include a hyperlink to a merchant's website.

In another embodiment, there is provided a computer-implemented method for providing content that is contextually relevant to an image published on a digital content platform. The method comprises a service provider processing unit performing the steps of: (a) receiving an image published on a digital content platform; (b) receiving referrer data; (c) submitting the image and the referrer data to an image-content matching engine to (1) identify the context of the image and (2) identify contextually relevant content based on the context of the image and the referrer data; and (d) providing the contextually relevant content to the digital content platform for publication proximate to the image. Step (b) may further include receiving image constants; and step (c) may further include the image-content matching engine identifying contextually relevant content based on the image constants. Additionally, step (b) may further include receiving a publisher hint string; and step (c) may further include the image-content matching engine identifying contextually relevant content based on the publisher hint string. Further, step (b) further may include receiving publisher data; and step (c) may further include the image-content matching engine identifying contextually relevant content based on the publisher data. The referrer data may include: a search string submitted by the end-user in order to be referred to the digital content platform; identification of a search engine that has referred the end-user to the digital content platform; a search string entered by end-user at the search engine prior to being referred to the digital content platform; a search string; and/or an HTTP referer. The image identification data may include a URL and/or an image file. The image-content matching engine may include a crowdsourcing network and/or an image recognition engine. The contextually relevant content may be an ad creative and/or may include a hyperlink to a merchant's website.

In one embodiment, there is provided a method of providing a contextually relevant advertisement, based on a digitally published image, the method comprising: (a) receiving the image from a publisher; (b) collecting data on the image and the referrer; (c) collecting data on one or more advertisers; and (d) based on the image, referrer, and advertisers, providing the publisher with an ad creative that is mutually relevant to the image and the one or more advertisers. Step (a) may be performed by having the image pushed, pulled, or scraped from the publisher. Step (b) may be performed by an image recognition engine and/or crowdsourcing. Step (b) may include identifying the context of the image. Step (c) may include identifying campaign metrics for the one or more advertisers. The method may further include: (e) providing the context of the image to the one or more advertisers. The ad creative may be provided by the one or more advertisers.

In still another embodiment, there is provided a method of facilitating a digital advertisement campaign, the method comprising: (a) identifying an image on a digital platform and referrer data; (b) analyzing the image to identify content-specific image data; (c) identifying, pulling, and/or matching an ad creative from the ad server to the image based on the content-specific image data and the referrer data; and (d) forwarding the ad creative to the digital platform. Step (b) may be performed by an image recognition engine and/or crowdsourcing.

In another embodiment, there is provided a method comprising: (a) steps for receiving the image from a publisher; (b) steps for analyzing the image to obtain the context of the image; (c) steps for matching an advertisement campaign to the image, based on the context of the image and referrer data received from the digital content platform; and (d) steps for providing the publisher with an ad creative that is mutually relevant to the context of the image, the referrer, and the advertisement campaign. The method may further include: (e) steps for providing the context of the image to one or more advertisers, such that the one or more advertisers can provide metrics for performing steps (c).

In yet another embodiment, there is provided a computer-based system, comprising: (a) means for receiving the image from a publisher; (b) means for analyzing the image to obtain the context of the image; (c) means for matching an advertisement campaign to the image, based on the context of the image and referrer data received from the digital content platform; and (d) means for providing the publisher with an ad creative that is mutually relevant to the context of the image, the referrer, and the advertisement campaign. The system may further include: (e) means for providing the context of the image to one or more advertisers, such that the one or more advertisers can provide metrics for performing means for matching an advertisement campaign to the image.

In one embodiment, the systems and methods presented are used for contextual advertising; in-image advertising; or equivalent digital media advertising aims.

### Communication Between Components/Parties Practicing the Present Invention.

In one embodiment, communication between the various parties and components of the present invention is accomplished over a network consisting of electronic devices connected either physically or wirelessly, wherein digital information is transmitted from one device to another. Such devices (e.g., end-user devices and/or servers) may include, but are not limited to: a desktop computer, a laptop computer, a handheld device or PDA, a cellular telephone, a set top box, an Internet appliance, an Internet TV system, a mobile device or tablet, or systems equivalent thereto. Exemplary networks include a Local Area Network, a Wide Area Network, an organizational intranet, the Internet, or networks equivalent thereto.

### Computer Implementation.

In one embodiment, the invention is directed toward one or more computer systems capable of carrying out the functionality described herein. The applications incorporated by reference above include one or more schematic drawings of a computer system capable of implement the methods presented above.

Computer systems for carrying out the presented methods may include one or more processors connected to a communication infrastructure (e.g., a communications bus, cross-over bar, or network). Computer systems may include a main memory, such as random access memory (RAM), and may also include a secondary memory, such as a hard disk drive, a removable storage drive, an optical disk drive, a flash memory device, a solid state drive, etc.

In this document, the terms “computer-readable storage medium,” “computer program medium,” and “computer usable medium” are used to generally refer to any non-transient computer readable media such as a removable storage drive, removable storage units, a hard disk installed in hard disk drive, and any other computer-readable media exclusive of transient signals. These computer program products provide computer software, instructions, and/or data to the computer system. These computer program products also serve to transform a general purpose computer into a special purpose computer programmed to perform particular functions, pursuant to instructions from the computer program products/software. Embodiments of the present invention are directed to such computer program products.

In an embodiment where the invention is implemented using software, the software may be stored in a computer program product and loaded into a computer system using a removable storage drive, an interface, a hard drive, a communications interface, or equivalents thereof. The control logic (software), when executed by a processor, causes the processor to perform the functions and methods described herein. Where appropriate, a processor, and/or associated components, and equivalent systems and sub-systems serve as “means for” performing selected operations and functions. Such “means for” performing selected operations and functions also serve to transform a general purpose computer into a special purpose computer programmed to perform said selected operations and functions.

Embodiments of the invention, including any systems and methods described herein, may also be implemented as instructions stored on any machine-readable medium, which may be read and executed by one or more machine components. A machine-readable medium may include any mechanism for storing or transmitting information in a form readable by a machine. For example, a machine-readable medium may include read only memory (ROM); random access memory (RAM); magnetic disk storage media; optical storage media; flash memory devices; solid state memory devices; or equivalents thereof. Further, firmware, software, routines, instructions may be described herein as performing certain actions.

In one embodiment, the methods are implemented primarily in hardware using, for example, hardware components such as application specific integrated circuits (ASICs). Implementation of the hardware state machine so as to perform the functions and methods described herein will be apparent to persons skilled in the relevant art(s). In yet another embodiment, the methods are implemented using a combination of both hardware and software.

In one embodiment, there is provided a computer-readable storage medium for providing a contextually relevant advertisements proximate to an image published on a digital content platform. The computer-readable medium includes instructions executable by at least one processing device that, when executed, cause the processing device to: (a) provide a publisher with a reference script for publication with an image on a digital content platform, wherein the reference script is a computer-readable instruction that causes an end-user device to send data to a service provider processing unit, and wherein the data includes (1) image identification data, and (2) referrer data; (b) receive the data from a publisher; (c) submit the data to an image-content matching engine, wherein the image identification data and the referrer data are used to match a contextually relevant advertisement to the image; and provide the contextually relevant advertisement to the end-user device for publication proximate to the image on the digital content platform.

In another embodiment, there is provided a computer-readable storage medium for providing content that is contextually relevant to an image published on a digital content platform. The computer-readable medium includes instructions executable by at least one processing device that, when executed, cause the processing device to: (a) receive an image published on a digital content platform; (b) receive referrer data; (c) submit the image and the referrer data to an image-content matching engine to (1) identify the context of the image and (2) identify contextually relevant content based on the context of the image and the referrer data; and (d) provide the contextually relevant content to the digital content platform for publication proximate to the image.

In one embodiment, there is provided a computer-readable storage medium, having instructions executable by at least one processing device that, when executed, cause the processing device to: (a) receive an image from a publisher; (b) collect data on the image; (c) collect data on one or more advertisers; (d) collect referrer data; (e) based on the data collected, provide the publisher with an ad creative that is mutually relevant to the image and the one or more advertisers; and/or (f) provide the context of the image and/or the referrer data to the one or more advertisers.

In another embodiment, there is provided a computer-readable storage medium, having instructions executable by at least one processing device that, when executed, cause the processing device to: (a) receive an image from a publisher; (b) analyze the image to obtain the context of the image; (c) match an advertisement campaign to the image, based on the context of the image and referrer data received from the publisher; (d) provide the publisher with an ad creative that is mutually relevant to the context of the image, the referrer, and the advertisement campaign; and/or (e) provide the context of the image to one or more advertisers, such that the one or more advertisers can provide metrics for matching.

### Conclusion.

The foregoing description of the invention has been presented for purposes of illustration and description. It is not intended to be exhaustive or to limit the invention to the precise form disclosed. Other modifications and variations may be possible in light of the above teachings. The embodiments were chosen and described in order to best explain the principles of the invention and its practical application, and to thereby enable others skilled in the art to best utilize the invention in various embodiments and various modifications as are suited to the particular use contemplated. It is intended that the appended claims be construed to include other alternative embodiments of the invention; including equivalent structures, components, methods, and means.

Accordingly, it is to be understood that this invention is not limited to particular embodiments described, and as such may vary. It is also to be understood that the terminology used herein is for the purpose of describing particular embodiments only, and is not intended to be limiting.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible. Further, each system component and/or method step presented should be considered a “means for” or “step for” performing the function described for said system component and/or method step. As such, any claim language directed to a “means for” or “step for” performing a recited function refers to the system component and/or method step in the specification that performs the recited function, as well as equivalents thereof.

It is to be appreciated that the Detailed Description section, and not the Summary and Abstract sections, is intended to be used to interpret the claims. The Summary and Abstract sections may set forth one or more, but not all exemplary embodiments of the present invention as contemplated by the inventor(s), and thus, are not intended to limit the present invention and the appended claims in any way.

1. A method for providing a contextually relevant advertisements proximate to an image published on a digital content platform, the method comprising:
providing a publisher with a reference script for publication with an image on a digital content platform, wherein the reference script is a computer-readable instruction that causes an end-user device that is directed to the digital content platform with the image to send data to a service provider processing unit, and wherein the data includes (1) image identification data, and (2) referrer data associated with the directing of the end-user device to the digital content platform with the image; and
configuring a service provider processing unit to perform the steps of
(a) receiving the data from a publisher,
(b) submitting the data to an image-content matching engine, wherein the image identification data and the referrer data are used to match a contextually relevant advertisement to the image, and
(c) providing the contextually relevant advertisement to the end-user device for publication proximate to the image on the digital content platform.

2. The method of claim 1, wherein the image identification data includes an image uniform resource locator (URL).

3. The method of claim 1, wherein the image identification data includes an image file.

4. The method of claim 1, wherein the referrer data includes a search string submitted by the end-user in order to be referred to the digital content platform.

5. The method of claim 1, wherein the referrer data includes identification of a search engine that has referred the end-user to the digital content platform.

6. The method of claim 5, wherein the referrer data includes a search string entered by end-user at the search engine prior to being referred to the digital content platform.

7. The method of claim 1, wherein the referrer data includes a search string.

8. The method of claim 1, wherein the referrer data includes an HTTP referer.

9. The method of claim 1, wherein the image-content matching engine includes a crowdsourcing network.

10. The method of claim 1, wherein the image-content matching engine includes an image recognition engine.

11. The method of claim 1, wherein the contextually relevant advertisement is provided in the form of an ad creative.

12. The method of claim 1, wherein the contextually relevant advertisement includes a hyperlink to a merchant's website.

13. The method of claim 1, wherein the image data further includes image constants, and wherein the image constants are also used by the image-content matching engine to match the contextually relevant advertisement to the image.

14. The method of claim 1, wherein the image data further includes a publisher hint string, and wherein the publisher hint string is also used by the image-content matching engine to match the contextually relevant advertisement to the image.

15. The method of claim 1, wherein the image data further includes publisher data, and wherein the publisher data is also used by the image-content matching engine to match the contextually relevant advertisement to the image.

16. A computer-implemented method for providing content that is contextually relevant to an image published on a digital content platform, the method comprising a service provider processing unit performing the steps of:
(a) receiving an image published on a digital content platform;
(b) receiving referrer data associated with a directing of an end-user device to the digital content platform with the image;
(c) submitting the image and the referrer data to an image-content matching engine to (1) identify the context of the image and (2) identify contextually relevant content based on the context of the image and the referrer data; and
(d) providing the contextually relevant content to the digital content platform for publication proximate to the image.

17. The method of claim 16, wherein the referrer data includes a search string submitted by the end-user in order to be referred to the digital content platform.

18. The method of claim 16, wherein the referrer data includes identification of a search engine that has referred the end-user to the digital content platform.

19. The method of claim 18, wherein the referrer data includes a search string entered by end-user at the search engine prior to being referred to the digital content platform.

20. The method of claim 16, wherein the referrer data includes a search string.

21. The method of claim 16, wherein the referrer data includes an HTTP referer.

22. The method of claim 16, wherein the image identification data includes an image uniform resource locator (URL).

23. The method of claim 16, wherein the image identification data includes an image file.

24. The method of claim 16, wherein the image-content matching engine includes a crowdsourcing network.

25. The method of claim 16, wherein the image-content matching engine includes an image recognition engine.

26. The method of claim 16, wherein step (b) further includes receiving image constants; and step (c) further includes the image-content matching engine identifying contextually relevant content based on the image constants.

27. The method of claim 16, wherein step (b) further includes receiving a publisher hint string; and step (c) further includes the image-content matching engine identifying contextually relevant content based on the publisher hint string.

28. The method of claim 16, wherein step (b) further includes receiving publisher data; and step (c) further includes the image-content matching engine identifying contextually relevant content based on the publisher data.

29. The method of claim 16, wherein the contextually relevant content is an ad creative.

30. The method of claim 16, wherein the contextually relevant content includes a hyperlink to a merchant's website.
